(19) United States
(12) Patent Application Publication
(10) Pub. No.: US 2009/0002426 A1
(43) Pub. Date: Jan. 1, 2009

(54) INKJET IMAGE FORMING APPARATUS AND CONTROL METHOD THEREOF

(75) Inventors: Sung June JUNG, Suwon-si (KR); Jae Young Chang, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/113,301

(22) Filed: May 1, 2008

(30) Foreign Application Priority Data
Jun. 26, 2007 (KR) 2007-63157

(51) Int. Cl. B41J 29/38

(52) U.S. Cl. 347/17

(57) ABSTRACT

An inkjet image forming apparatus sets an initial ink temperature according to a dot area of a dot-sized pattern printed by the printer head, and calculates an ink temperature by applying the initial ink temperature to a temperature conversion equation. The inkjet image forming apparatus prevents a measurement error of the temperature sensor from valid data after the printing process is terminated, so that it can correctly measure the ink temperature of the printer head.

### CROSS-REFERENCE TO RELATED APPLICATIONS

This application claims priority under 35 U.S.C. §119(a) from Korean Patent Application No. 2007-0063157, filed on Jun. 26, 2007 in the Korean Intellectual Property Office, the disclosure of which is incorporated herein by reference in its entirety.

### BACKGROUND OF THE INVENTION

1. Field of the Invention

The present general inventive concept relates to an inkjet image forming apparatus to prevent a printer head from being overheated.

2. Description of the Related Art

Generally, inkjet printer head injects ink bubbles at a desired location on a recording paper, so that an image having a predetermined color is printed on the paper. The inkjet printer head is mainly classified into a thermal-driving inkjet printer head based on the injection mechanism of ink bubbles and an inkjet printer head based on a piezoelectric driving scheme according to the injection mechanism of the ink bubbles. The thermal-driving inkjet printing head generates ink bubbles using a heat source, and injects the ink bubbles by an expansion force of the bubbles. The piezoelectric-driving inkjet printer head injects the ink bubbles by a pressure applied to the ink by modification of a piezoelectric substance.

The ink-bubbles injection mechanism for use in the thermal-driving inkjet printing head will hereinafter be described in detail.

If a pulse-shaped current signal flows in a heater composed of a resistance-heating material, the heater generates heat, so that the ink adjacent to the heater is instantaneously heated up to about 300° C. Therefore, ink bubbles occur, the bubbles are increased, so that the increased bubbles apply the pressure to the inside of the ink chamber fully filled with the ink. The ink adjacent to the nozzle is configured in the form of ink bubbles via the nozzle, and the ink bubbles are sprayed out of the ink chamber.

The ink injection amount of the inkjet printer head is greatly changed according to the temperature of the printer head, and greatly affects the printing quality. Therefore, a temperature sensor is mounted in the printer head, and the ink temperature of the printer head is measured by the temperature sensor.

The temperature sensor contained in the inkjet printer head is generally used as a thermistor. The resistance value of the thermistor is hanged according to the increasing temperature of the printing head during the printing process. So, the printer-head temperature is calculated according to the variation of the thermistor's resistance, the ink temperature is estimated on the basis of the calculated printer-head temperature, and the heater of the nozzle is controlled according to the estimated ink temperature, so that the ink injection amount can also be adjusted.

In this way, the conventional apparatus uses the above method for estimating the ink temperature on the basis of the resistance variation of the temperature sensor. The resistance value of the temperature sensor indicates a relative indicator of the ink temperature. In order to directly induce the ink temperature from the resistance value of the temperature sensor, the conventional art must pre-measure the relationship between the air temperature of the image forming apparatus and the resistance of the temperature sensor.

In other words, the conventional art measures the air temperature of the inkjet image forming apparatus, decides an initial value of the temperature sensor of the printer head on the basis of the measured air temperature, and measures the ink temperature caused by the printing process according to the variation of the output value of the temperature sensor.

If a long period of time does not elapse after the printing process has been completed, the ink temperature contained in the ink chamber heated for the printing process is gradually lowered, but the measured temperature corresponding to the resistance value of the temperature sensor is relatively and rapidly lowered. This phenomenon can be solved after a long period of time elapsed after the interruption of the printing process, so that the temperature measured by the temperature sensor is different from the actual ink temperature while the above-mentioned phenomenon is not solved, resulting in the occurrence of a measurement error and a deterioration of the printing quality.

### SUMMARY OF THE INVENTION

The present general inventive concept provides an inkjet image forming apparatus which set an initial ink temperature according to a dot area of a dot-sized pattern printed by a printer head, so that it can correctly measure an ink temperature of the printer head, and a method of controlling the inkjet image forming apparatus.

Additional aspects and/or advantages of the present general inventive concept will be set forth in part in the description which follows and, in part, will be obvious from the description, or may be learned by practice of the general inventive concept.

The foregoing and/or other aspects and utilities of the present general inventive concept can be achieved by providing an inkjet image forming apparatus including a printer head, a temperature sensor to measure an ink temperature of the printer head, a sensor to measure a dot area of a dot-sized pattern printed on a printing medium via the printer head, and a controller to set an initial ink temperature according to the dot area measured by the sensor, and to calculate the ink temperature of the printer head using the set initial ink temperature and information measured by the temperature sensor.

The sensor may be an optical sensor having a light-emitting element and a light-receiving element.

The temperature sensor may be a thermal-resistance thermistor having a resistance value changing with temperature.

The apparatus may further include a memory to store information of the dot-sized pattern and information of a temperature-conversion equation.

The apparatus may further include a converter to convert an output voltage corresponding to the resistance value of the temperature sensor into digital data, and to transmit the digital data to the controller.

The controller may calculate the ink temperature using a temperature conversion equation “Tf=Ti+(1/α)×((Rf/Ri)−1)”, where “Ri” is indicative of an initial resistance value of the temperature sensor, “Rf” is indicative of a measured resistance value of the temperature sensor, “α” is indicative of a temperature constant of the temperature sensor and is denoted by Ω/° C., “Ti” is indicative of an initial ink temperature, and “Tf” is indicative of a measured ink temperature.

The dot-sized pattern may include at least one dot.

The foregoing and/or other aspects and utilities of the present general inventive concept may also be achieved by providing an inkjet image forming apparatus including a printer head to print a dot-sized pattern on a printing medium, a temperature sensor to measure an ink temperature of the printer head, an optical sensor to include a light-emitting element and a light-receiving element mounted to a downstream side of the printer head, and to measure a dot area of the dot-sized pattern printed on the printing medium, a memory to store information of the dot-sized pattern and information of a temperature conversion equation used to calculate the ink temperature, and a controller to set an initial ink temperature according to the dot area measured by the optical sensor, and to calculate the ink temperature of the printer head by applying the established initial ink temperature and information measured by the temperature sensor to the temperature conversion equation stored in the memory.

The controller may search for the ink temperature corresponding to the measured dot area in the memory, and may set the searched ink temperature to the initial ink temperature.

The foregoing and/or other aspects and utilities of the present general inventive concept may also be achieved by providing a method of controlling an inkjet image forming apparatus having a temperature sensor used to measure an ink temperature of a printer head, the method including printing a dot-sized pattern using the printer head; measuring a dot area of the dot-sized pattern using an optical sensor, setting an initial ink temperature of the printer head according to the measured dot area, calculating an ink temperature of the printer head using the established initial ink temperature and a temperature conversion equation, and controlling an ink injection amount according to the calculated ink temperature, and performing a printing process.

The setting of the initial ink temperature may include searching for information indicating a relationship between the dot area pre-stored in a memory and the ink temperature, and setting the ink temperature corresponding to the measured dot area to an initial ink temperature according to the searched result.

The temperature conversion equation may be denoted by “Tf=Ti+(1/α)×((Rf/Ri)−1)”, where “Ri” is indicative of an initial resistance value of the temperature sensor, “Rf” is indicative of a measured resistance value of the temperature sensor, “α” is indicative of a temperature constant of the temperature sensor and is denoted by Ω/° C., “Ti” is indicative of an initial ink temperature, and “Tf” is indicative of a measured ink temperature.

The method may further include if a power-supply voltage is applied to the apparatus, applying a process for calculating the ink temperature of the printer head to the apparatus.

The method may further include if the printing process re-starts after a previous printing process is completed, applying a process of calculating the ink temperature of the printer head to the re-starting process.

The foregoing and/or other aspects and utilities of the present general inventive concept may also be achieved by providing a method of an inkjet image forming apparatus, the method including measuring a temperature of a printer head, measuring a dot area of a dot-sized pattern printed on a printing medium via the printer head, and setting an initial ink temperature according to the dot area measured by the sensor, and calculating the ink temperature of the printer head using the established initial ink temperature and information measured by the temperature sensor.

The foregoing and/or other aspects and utilities of the present general inventive concept may also be achieved by providing an inkjet image forming apparatus including a printer head to form an pattern having one or more dots, and a controller to set an initial ink temperature according to a dot area of the dots of the pattern printed on a printing medium, and to control the print head according to the set initial ink temperature.

The apparatus may further include a heater to heat ink of the printer head and a driving unit to generate a driving signal to the heater, and the controller may control the driving unit to adjust the driving signal according to the set initial ink temperature.

The driving unit may adjust at least one of a value or length of the driving signal according to the set initial ink temperature.

The controller may control the printer head to reduce a temperature difference between a temperature of the printer head and a temperature of ink contained in the printer head.

The controller may set the initial ink temperature according to the dot area of the pattern and a temperature of the printer head to correspond to an ink temperature.

The apparatus may further include a temperature sensor to detect a temperature of the printer head, and the controller may set the initial ink temperature according to the detected temperature and the dot area of the dots of the pattern printed on the printing medium, and control the print head according to the set initial ink temperature.

The apparatus may further include a sensor to measure the dot area of the pattern from the printing medium.

The controller may control the print head according to a variance of temperatures of the printer head and a variance of ink temperatures including the initial ink temperature.

The foregoing and/or other aspects and utilities of the present general inventive concept may also be achieved by providing an inkjet image forming apparatus including a printer head to form a first image on a first medium; a detector to detect a temperature of the printer head, and a controller to set an initial ink temperature according to the temperature of the printer head and a characteristic of the first image of the first printing medium, and to control the print head to form a second image on a second printing medium according to the set initial ink temperature.

The foregoing and/or other aspects and utilities of the present general inventive concept may also be achieved by providing an inkjet image forming apparatus including a printer head to form an image in a printing process and to form a first image on a first medium in a second printing process, a detector to detect a temperature of the printer head during the printing process and a second temperature a period of time after the printing process, and a controller to set an initial ink temperature according to the temperature and the second temperature of the printer head and a characteristic of the first image of the first printing medium, and to control the print head to form a second image on a second printing medium in the second printing process according to the set initial ink temperature.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a structural diagram illustrating an inkjet image forming apparatus according to an embodiment of the present general inventive concept;

FIG. 2 is a block diagram illustrating an inkjet image forming apparatus according to an embodiment of the present general inventive concept;

FIG. 3 is a structural diagram illustrating a temperature sensor mounted to a printer head of the inkjet image forming apparatus according to an embodiment of the present general inventive concept;

FIG. 4 is a graph illustrating a relationship between the ink temperature of the printer head and the measurement temperature of the temperature sensor according to the elapsing time generated after the inkjet image forming apparatus terminates the printing process according to the present general inventive concept;

FIG. 5A illustrates a dot-sized pattern printed on the printing medium at the ink temperature of 30°, FIG. 5B illustrates a dot-sized pattern printed on the printing medium at the ink temperature of 50°, and FIG. 5C illustrates a dot-sized pattern printed on the printing medium at the ink temperature of 70°;

FIG. 6 is a graph illustrating a relationship between the dot area created by the measurement of the dot-sized pattern and the ink temperature using the optical sensor according to the present general inventive concept; and

FIG. 7 is a flow chart illustrating a method of controlling the inkjet image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below to explain the present general inventive concept by referring to the figures.

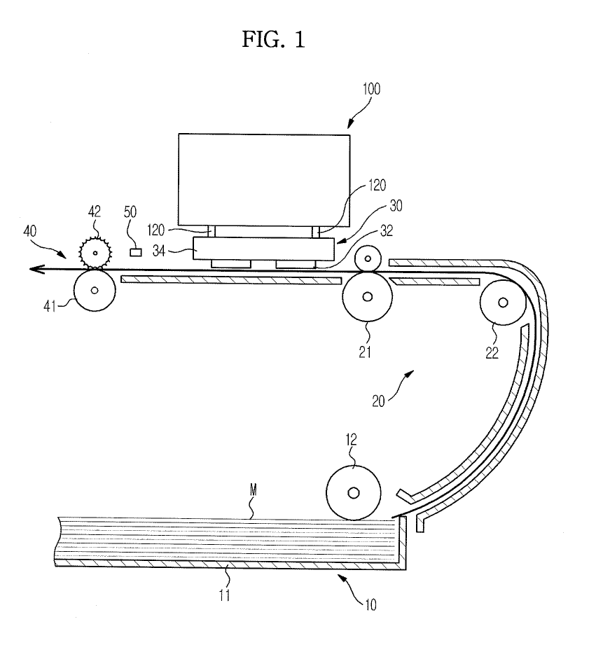

Referring to FIG. 1, an inkjet image forming apparatus according to an embodiment of the present general inventive concept includes a paper feeder 10 to provide a printing medium (M), such as a sheet of paper a transfer unit 20 to transfer the printing medium, a printer head 30 to form an image on the printing medium with the ink in a printing process, a discharger 40 to discharge the printed medium to an outside of the image forming apparatus, and an optical sensor to measure a dot area of a dot-sized pattern printed on the printing medium.

The paper feeder 10 includes a paper-feeding tray 11 on which the printing medium M is loaded, and a pickup roller to pick up the printing medium loaded on the paper-feeding tray 11 one by one. The transfer unit 20 includes a feeding roller 21 which transfers the printing medium picked up by the pickup roller to a lower part of the printer head 30 and is mounted to an inlet of the printer head 30, and an auxiliary roller 22 between the feeding roller 21 and the pickup roller 12.

The discharger 40 includes a discharging roller 41 and a start-wheel 42. The discharging roller 41 is located at a downstream side of the printer head 30 in a transferring direction of the printing medium (M). The star-wheel 42 is located to face the discharging roller 41 to feed the printing medium therebetween.

The ink provider 100 is connected to a channel unit 34 of the printer head 30 via an ink-circulating flow path 120. FIG. 1 is a conceptual diagram to illustrate the ink provider 100. However, the present general inventive concept is not limited thereto. The ink provider 100 can be integrated with the printer head 30 in the form of a cartridge, or may be installed in an independent structure from the printer head 30 to be connected to the printer head 30 through a connection.

The printer head 30 according to the present general inventive concept is an array printer head equipped with a nozzle which has the length corresponding to a width of the printing medium. The printer head 30 includes a plurality of head-chips 32 to spray the ink on the printing medium M at a fixed location. Each head chip 32 includes a plurality of nozzles to spray out the ink, so that it can spray out the same-colored ink or different-colored ink (e.g., Cyan, Magenta, Yellow, and Black colors) via the nozzles. Here, it is possible that another type of printer heads, i.e., a shuttle type print head, can be used as the printer head 30.

The printer head 30 includes the channel unit 34 to direct the ink supplied from the ink provider 100. One or more ink channels (not illustrated) are formed in the channel unit 34, so that the ink can be applied from the ink provider 100 to the nozzles of the respective head chips 32 of the printer head 30 in different ways (directions or channels).

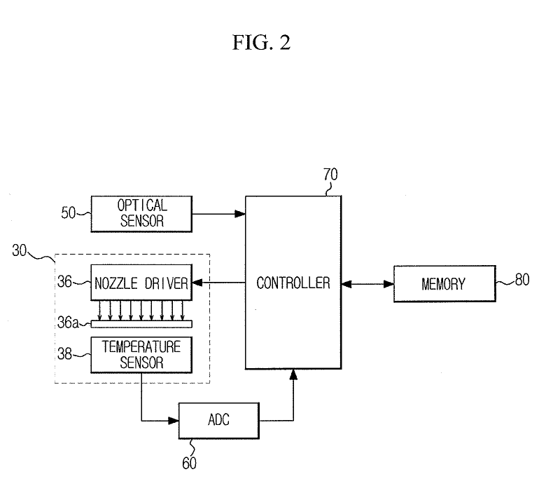

Referring to FIG. 2, the printer head 30 includes a nozzle driver 36 and a temperature sensor 38. The nozzle driver 36 transmits a current signal to heaters 36a corresponding to the nozzles to generate ink bubbles such that the ink is ejected via the corresponding nozzle. The temperature sensor 38 is installed in the printer head to measure the temperature.

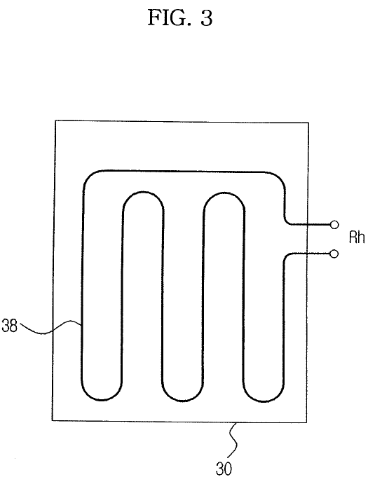

Referring to FIG. 3, the temperature sensor 38 may be implemented with a thermal-resistance thermistor arranged in the printer head 30, so that a resistance of the thermistor is changed with a temperature of the printer head. An output voltage (Rh) corresponding to a resistance value changing with the temperature of the printer head 30 is applied to a converter 60.

The converter 60 converts the output voltage into digital data, and transmits the digital data to the controller 70. The controller 70 decodes the converted data to recognize a printer temperature, i.e., a temperature of the printer head 30.

The controller 70 predicts an ink temperature corresponding to the printer temperature measured by the temperature sensor 38 during a printing process, and controls the nozzle driver 36 according to the predicted ink temperature, so that an ink injection amount is adjusted.

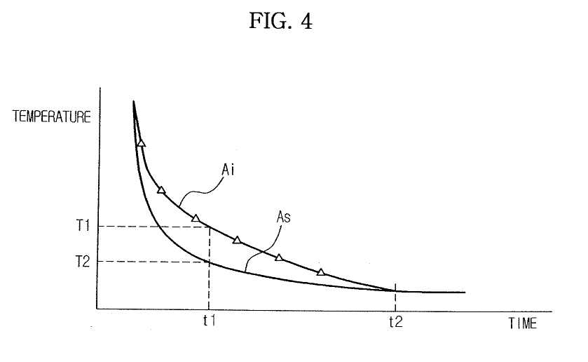

During the printing process, the ink temperature contained in an ink chamber of the printer head 30 is heated due to characteristics of the printer head 30 based on a thermal driving scheme. Although the printing process is terminated, a temperature difference between the temperature of the printer head and the ink temperature during a predetermined period of time is changed. That is, the temperature of the printer head and the ink temperature may be same or similar to each other during an ink ejecting process. However, the temperature of the printer head and the ink temperature may not be same or similar to each other after a printing process. After the predetermined period of time, the temperature of the printer head and the ink temperature may be lowed to be same or similar to each other. As illustrated in FIG. 4, an actual ink temperature (Ai) may be equal to a measurement temperature (As) of the temperature sensor during a printing process or after a considerably long period of time (t2) has elapsed after the printing process, and a temperature (T2) of the printer head measured by the temperature sensor 38 becomes lower than an actual ink temperature (T1) of the ink at the time t1 arranged after the printing process.

The actual ink temperature Ai is checked at a specific time at which the above-mentioned temperature difference may occur, and the ink temperature is predicted according to a variation of a resistance of the temperature sensor 38 on the basis of the ink temperature acquired by the printing process.

This embodiment experimentally prints a predetermined dot-sized pattern on the printing medium to check the ink temperature in consideration of a dot-size changing with the ink temperature, and measures a degree of the dot-size variation using an optical sensor 50 as illustrated in FIG. 2.

The information of the dot-sized pattern is stored in the memory 80.

The dot-sized pattern includes at least one dot to recognize different dot sizes changing with the ink temperature. The dots may be spaced apart from each other at intervals of a predetermined distance, so that the dot-size variation is measured according to the ink temperature.

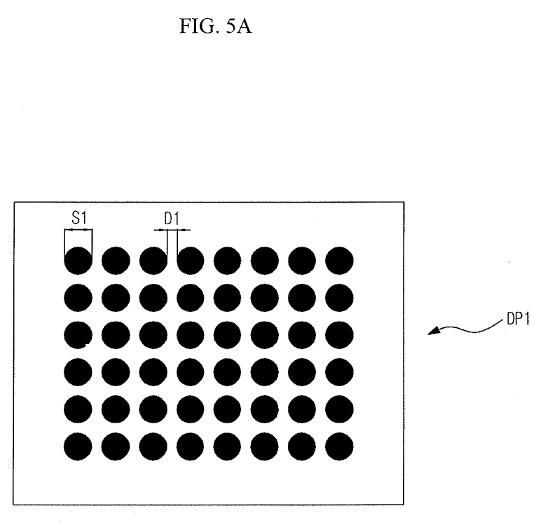

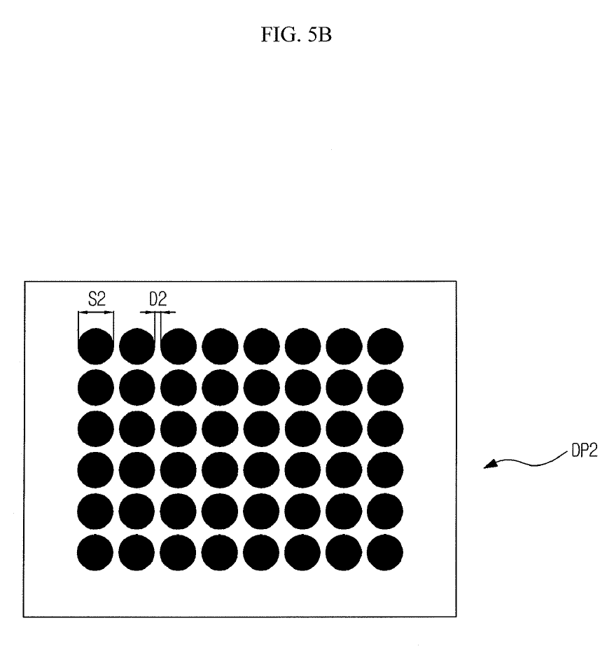

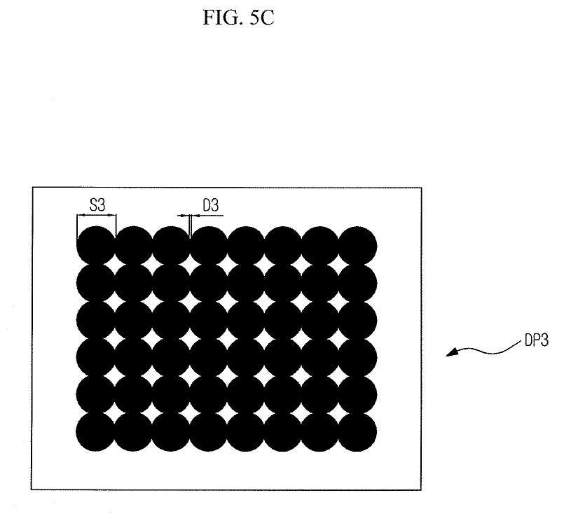

For example, in the case of comparing a dot-sized pattern (DP2) printed on the printing medium at the temperature of 50° C. (See FIG. 5B) with an other dot-sized pattern (DP1) printed on the printing medium at the temperature of 30° C. (See FIG. 5A), a dot size S2 of each dot of the pattern DP2 is larger than a dot size S1 of the other pattern DP1. The dot size S1 of each dot of the pattern DP1 is less than a dot size S3 of the pattern DP3, which is printed on the printing medium at the temperature of 70° C. (See FIG. 5C). Here, the dots of the patterns DP1, DP2, and DP3 may be spaced by distances D1, D2, and D3, respectively.

Although the same-dot-sized pattern is printed, the dot size of the dot-sized pattern is changed with the ink temperature. The variation of the dot size is measured by the optical sensor 50.

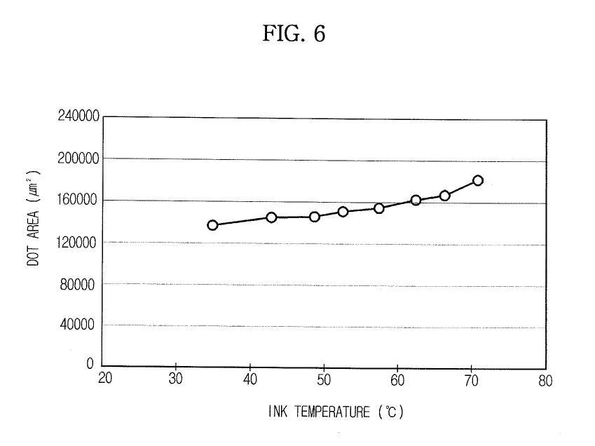

As illustrated in FIG. 6, a dot area may correspond to ink temperature. Information indicating a relationship between the dot area and the ink temperature is stored in the memory 80. Therefore, the controller 70 searches for information in the memory 80 on the basis of the dot area measuring the dot-sized pattern via the optical sensor 50, so that it can recognize the corresponding ink temperature.

The method of recognizing the ink temperature may include a process of printing the dot-sized pattern on the printing medium, so that it may be conducted when the printing process restarts after the previous printing process is terminated, or may also be conducted when the apparatus receives an initial power-supply signal to initiate a new printing process. In this way, the above-mentioned recognizing method is applied to recognize the initial ink temperature.

Prior to the printing process, a method may be used to estimate the temperature of the printer head, i.e., the ink temperature, using a predetermined temperature conversion equation according to a resistance variation of the temperature sensor 38 on the basis of the initial ink temperature.

The temperature conversion equation stored in the memory 80 is denoted by “Tf=Ti+(1/a)×((Rf/Ri)−1)” where “Ri” is indicative of an initial resistance value of the temperature sensor, “Rf” is indicative of a measured resistance value of the temperature sensor, “a” is indicative of a temperature constant of the temperature sensor and is denoted by Ω/° C., “Ti” is indicative of an initial ink temperature, and “Tf” is indicative of a measured ink temperature.

The controller recognizes the initial ink temperature Ti according to the dot area of the dot-sized pattern, and then recognizes the initial resistance value (Ri) according to the output voltage (Rh) of the temperature sensor 38. In this case, information indicating the relationship between the output voltage and the initial resistance value is stored in the memory 80.

Since the temperature constant “a” is stored in the memory 80, the controller 70 can recognize the ink temperature Tf using the temperature conversion equation after recognizing the initial ink temperature.

In this way, after the initial ink temperature (Ti) and the initial resistance value (Ri) are stored in the memory 80, the printing process can be performed. During the printing process, the resistance value (Rf) of the temperature sensor is applied to the temperature conversion equation, so that the measured temperature (Tf) is calculated, and an ink injection amount can be controlled by the calculated temperature (Tf), i.e., the ink temperature.

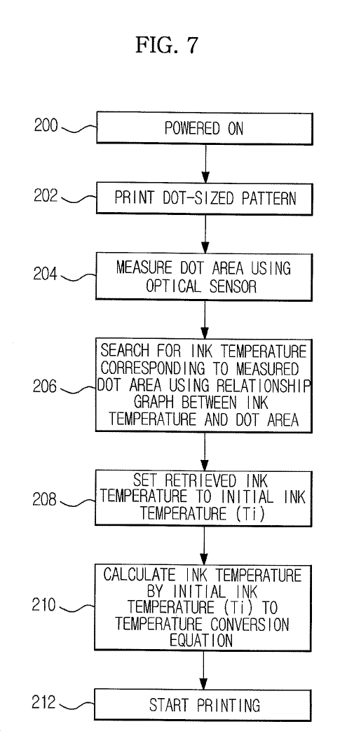

A method of controlling an inkjet image forming apparatus according to an embodiment of the present general inventive concept will hereinafter be described with reference to FIG. 7.

The embodiment of FIG. 7 illustrates an exemplary case in which a power-supply signal is firstly applied to a printing unit of the apparatus, but the scope of the present general inventive concept is not limited thereto, and can also be applied to other examples. The dot-sized pattern is tested when the initial ink temperature is recognized, and then the ink temperature is recognized according to the resistance value of the temperature sensor. The present general inventive concept can also be applied to another example to restart the printing process after the previous printing process has been finished, so that a detailed description thereof will herein be omitted for the convenience of description.

Referring to FIGS. 1 through 7, if the apparatus is powered on at operation 200, the controller 70 controls the nozzle driver 36 of the printer head 30 so that the dot-sized pattern is printed on the printing medium M using the dot-sized pattern information stored in the memory 80 at operation 202. In this case, the optical sensor 50 is located at a downstream of the printer head 30, so that it measures the dot area of the dot-sized pattern printed on the printing medium M, and applies the measured dot-area information to the controller 70 at operation 204.

The controller searches for the ink temperature corresponding to the measured dot area in the memory 80. This memory 80 includes information indicating the relationship between the dot area and the ink temperature, so that it can search for the ink temperature corresponding to the measured dot area at operation 206.

The controller 70 determines the retrieved ink temperature to be the initial ink temperature (Ti). In this case, the controller 70 recognizes the initial resistance value of the temperature sensor 30 according to the output voltage (Rh) of the temperature sensor 38, and stores the recognized initial resistance value in the memory 80 at operation 208.

Thereafter, the controller 70 receives data of the output voltage (Rh) indicating the resistance value (Rf) of the temperature sensor 38 from the converter 60, so that it can reply to the user's printing command generated from the interface unit (not shown). Then, the controller 70 applies the initial ink temperature (Ti), the initial resistance value (Ri), and the temperature constant (α) stored in the memory 80 to the temperature conversion equation, so that it can calculate the measured ink temperature (Tf) at operation 210.

The controller 70 controls the ink injection amount caused by the printing process on the basis of the calculated ink temperature (Tf).

Depending on the temperature of the printer head, the controller generates a driving signal to control a heater to heat ink to a desirable ink temperature from an initial ink temperature, so that a desirable dot size is obtained when the ink with the desirable ink temperature is ejected to form dots corresponding to an image.

According to the present general inventive concept, the driving signal may vary depending on the temperature of the printer head or the dot size of the ink dots formed on the printing medium. That is, the driving signal may have a low current or voltage or a shorter period of time to be applied to the heater when the temperature of the printer head is higher than a reference which means that a short period of time has passed after the printing process has bee terminated, such that a short heating time or a low heating source is necessary to increase the ink temperature. The driving signal may be a high current or voltage or a longer period of signal to be applied to the heater when the temperature of the printer head is lower than a reference which means that a longer period of time has passed after the printing process has bee terminated, such that a longer heating time or a high heating source is necessary to increase the ink temperature.

As described above, the temperature of the printer head and/or the dot size of the ink dot can be used to generate the driving signal to control the ink temperature. It is also possible that the temperature of the printer head and a time difference between a time when the previous printing process is terminated, and a time when a new printing process is performed can be used to adjust the driving signal to control the heater to heat the ink to a desirable ink temperature.

As described above, according to the present general inventive concept, the ink temperature can be controlled to obtain a desirable dot size, and a desirable heating time and/or a desirable heating current/voltage can be controlled to obtain a desirable ink temperature.

According to the present general inventive concept, an inkjet image forming apparatus may include a printer head to form an image in a printing process and to form a first image on a first medium in a second printing process, a detector to detect a temperature of the printer head during the printing process and a second temperature a period of time after the printing process, and a controller to set an initial ink temperature according to the temperature and the second temperature of the printer head and a characteristic of the first image of the first printing medium, and to control the print head to form a second image on a second printing medium in the second printing process according to the set initial ink temperature, so that the heat or the ink is prevented from being overheated during the second printing process.

As is apparent from the above description, the inkjet image forming apparatus according to the present general inventive concept measures the dot area of the dot-sized pattern changing with the ink temperature, sets the initial ink temperature according to the measured result, calculates the ink temperature during the printing process, prevents the measurement error from being caused by the temperature sensor, so that it can correctly measure the ink temperature, resulting in the increase in the printing quality.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. An inkjet image forming apparatus comprising:
a printer head;
a temperature sensor to measure a temperature of the printer head;
a sensor to measure a dot area of a dot-sized pattern printed on a printing medium via the printer head; and
a controller to set an initial ink temperature according to the dot area measured by the sensor, and to calculate an ink temperature of the printer head using the set initial ink temperature and information measured by the temperature sensor.

2. The apparatus of claim 1, wherein the sensor is an optical sensor composed of a light-emitting element and a light-receiving element.

3. The apparatus of claim 1, wherein the temperature sensor is a thermal-resistance thermistor having a resistance value changing with temperature.

4. The apparatus according to claim 1, further comprising:
a memory to store information of the dot-sized pattern and information of a temperature-conversion equation.

5. The apparatus of claim 4, further comprising:
a converter to convert an output voltage corresponding to a resistance value of the temperature sensor into digital data, and to transmit the digital data to the controller.

6. The apparatus of claim 1, wherein the controller calculates the ink temperature using a temperature conversion equation “Tf=Ti+(1/α)×((Rf/Ri)−1)”,
where “Ri” is indicative of an initial resistance value of the temperature sensor, “Rf” is indicative of a measured resistance value of the temperature sensor, “a” is indicative of a temperature constant of the temperature sensor and is denoted by Ω/° C., “Ti” is indicative of an initial ink temperature, and “Tf” is indicative of a measured ink temperature.

7. The apparatus of claim 1, wherein the dot-sized pattern includes at least one dot.

8. The apparatus of claim 1, further comprising:
a memory to store information of the dot-sized pattern and information of a temperature conversion equation to calculate the ink temperature,
wherein:
the printer head to print the dot-sized pattern on the printing medium;
the sensor comprises an optical sensor including a light-emitting element and a light-receiving element mounted to a downstream side of the printer head to measure the dot area of the dot-sized pattern printed on the printing medium; and
the controller sets the initial ink temperature according to the dot area measured by the optical sensor, and calculates the ink temperature of the printer head by applying the set initial ink temperature and information measured by the temperature sensor to the temperature conversion equation stored in the memory.

9. The apparatus of claim 8, wherein the controller searches for the ink temperature corresponding to the measured dot area in the memory, and sets the searched ink temperature to the initial ink temperature.

10. A method of controlling an inkjet image forming apparatus having a temperature sensor to measure an ink temperature of a printer head, the method comprising:
printing a dot-sized pattern using the printer head;
measuring a dot area of the dot-sized pattern using an optical sensor;
establishing an initial ink temperature of the printer head according to the measured dot area;
calculating an ink temperature of the printer head using the established initial ink temperature and a temperature conversion equation; and
controlling an ink injection amount according to the calculated ink temperature, and performing a printing process.

11. The method of claim 10, wherein the establishing of the initial ink temperature includes:
searching for information indicating a relationship between the dot area pre-stored in a memory and the ink temperature, and setting the ink temperature corresponding to the measured dot area to an initial ink temperature according to the searched result.

12. The method of claim 10, wherein the temperature conversion equation is denoted by “Tf=Ti+(1/α)×((Rf/Ri)−1)”,
where “Ri” is indicative of an initial resistance value of the temperature sensor, “Rf” is indicative of a measured resistance value of the temperature sensor, “a” is indicative of a temperature constant of the temperature sensor and is denoted by Ω/° C., “Ti” is indicative of an initial ink temperature, and “Tf” is indicative of a measured ink temperature.

13. The method of claim 10, further comprising:
if a power-supply voltage is applied to the apparatus, applying a process of calculating the ink temperature of the printer head to the apparatus.

14. The method of claim 10, further comprising:
if the printing process re-starts after a previous printing process is completed, applying a process of calculating the ink temperature of the printer head to a re-starting process.

15. An inkjet image forming apparatus comprising:
a printer head to form an pattern having one or more dots; and
a controller to set an initial ink temperature according to a dot area of the dots of the pattern printed on a printing medium, and to control the print head according to the set initial ink temperature.

16. The apparatus of claim 15, further comprising:
a heater to heat ink of the printer head; and
a driving unit to generate a driving signal to the heater,
wherein the controller controls the driving unit to adjust the driving signal according to the set initial ink temperature.

17. The apparatus of claim 16, wherein the driving unit adjusts at least one of a value or length of the driving signal according to the set initial ink temperature.

18. The apparatus of claim 15, wherein the controller controls the printer head to reduce a temperature difference between a temperature of the printer head and a temperature of ink contained in the printer head.

19. The apparatus of claim 15, wherein the controller sets the initial ink temperature according to the dot area of the pattern and a temperature of the printer head to correspond to an ink temperature.

20. The apparatus of claim 15, further comprising:
a temperature sensor to detect a temperature of the printer head,
wherein the controller sets the initial ink temperature according to the detected temperature and the dot area of the dots of the pattern printed on the printing medium, and to control the print head according to the set initial ink temperature.

21. The apparatus of claim 15, further comprising:
a sensor to measure the dot area of the pattern from the printing medium.

22. The apparatus of claim 15, wherein the controller controls the print head according to a variance of temperatures of the printer head and a variance of ink temperatures including the initial ink temperature.
